(19) United States
(12) Patent Application Publication
(10) Pub. No.: US 2026/0229116 A1
(43) Pub. Date: Aug. 6, 2026

(54) METHODS AND SYSTEMS FOR ADVANCED TRAFFIC ANALYSIS

(71) Applicant: Chester Michael Skwarcan, Danville, IN (US)

(72) Inventor: Chester Michael Skwarcan, Danville, IN (US)

(21) Appl. No.: 19/576,129

(22) Filed: Mar. 24, 2026

Related U.S. Application Data
(63) Continuation-in-part of application No. 19/554,895, filed on Mar. 3, 2026.
Application No. 19/554,895 is a continuation of application No. 18/425,481, filed on Jan. 29, 2024, now Pat. No. 12,573,293.
(60) Provisional application No. 63/519,993, filed on Aug. 16, 2023.

(51) Int. Cl. G08G 1/08; G06V 20/52; G06V 20/62; G08G 1/01; G08G 1/017

(52) U.S. Cl. CPC G08G 1/08; G06V 20/52; G06V 20/625; G08G 1/0133; G08G 1/017

(57) ABSTRACT

A system and method for advanced traffic analysis and management are provided, utilizing a network of sensors, including license plate cameras and alternative sources such as radar or inductive loops, to capture granular traffic data. The data is transmitted to a central or distributed server including modules for collection, anonymization (e.g., via hashing or differential privacy), storage, and analysis using machine learning models. External data from third-party sources, such as weather or event feeds, is merged with captured data to form combined datasets for identifying traffic conditions, including volumes, patterns, anomalies, and cross-jurisdictional flows. Outputs include commands to traffic infrastructure (e.g., signal timing adjustments), notifications to user interfaces, responses to inquiries, and exported datasets for further processing. The approach enables real-time predictive insights, privacy-compliant integration, and scalable urban planning while repurposing existing infrastructure for enhanced efficiency and safety.

### CROSS-REFERENCE TO RELATED APPLICATIONS

This application is a continuation-in-part of U.S. application Ser. No. 19/554,895, filed Mar. 3, 2026, which is a continuation of Ser. No. 18/425,481, filed Jan. 29, 2024, which claims the benefit of U.S. Provisional Application No. 63/519,993, filed on Aug. 16, 2023, the entire disclosures of which are hereby incorporated by reference.

### FIELD OF THE DISCLOSURE

The present disclosure relates to devices, systems, and methods for analyzing traffic information and providing actionable intelligence based upon the analyses.

### BACKGROUND

Current traffic data collection methods, while functional, present several key limitations. For example, traditional methods often rely on sporadic, manual data collection that provides only snapshots of traffic flow at specific times. This results in an inability to monitor traffic patterns in real-time or respond quickly to sudden changes or anomalies. Additionally, manual traffic surveys require substantial human resources and can be time-consuming and expensive to conduct. These costs increase significantly when long-term, continuous data is required. Moreover, conventional methods often simply count vehicles and do not consider vehicle-specific information. As a result, they provide an imprecise picture of actual traffic patterns on a vehicle-by-vehicle basis and may miss important trends or changes. Such systems also typically operate independently of traffic management systems (e.g., traffic signal timing controls), resulting in a disconnect between data collection and analysis, and actual traffic control measures. In addition to real-time limitations, existing solutions often lack the ability to forecast future traffic patterns based on historical data, which could help in strategic traffic planning and management. Also, the data collected by conventional systems is often not easily accessible or usable by third-party developers, limiting the potential for innovative applications that could enhance traffic management and planning. As such, there exists a need to provide an improved traffic analysis system that enables more efficient, precise, and integrated traffic data collection and analysis.

### SUMMARY

In one embodiment, the present disclosure provides a method of controlling traffic management infrastructure, comprising: capturing images of vehicle license plates using a plurality of cameras; converting the images to license plate data including license plate characters; transmitting the license plate data via a first network to a central server having a data collection module, a data anonymization module, a data storage module and a data analysis module; extracting, by the data collection module, the license plate characters from the license plate data; packaging, by the data collection module, the license plate characters in license plate files; anonymizing, by the anonymization module, the license plate files; storing, by the data storage module, the anonymized license plate files; analyzing, by the data analysis module, the anonymized license plate files to identify a traffic condition; and outputting, by the data analysis module, at least one command to at least one component of traffic management infrastructure, thereby causing the component to adjust an aspect of traffic management based upon the identified traffic condition. In one aspect of this embodiment, the plurality of cameras are motion-sensitive, high-speed traffic cameras. In another aspect, transmitting the images via the network to the central server occurs in near real-time with the capturing step. In yet another aspect, extracting includes extracting, by the data collection module, timestamp data, vehicle type and camera ID data from the license plate data. In a variant of this aspect, packaging includes packaging, by the data collection module, the timestamp data, the vehicle type and the camera ID data into the license plate files. In another aspect, anonymizing includes transforming, by the anonymization module, characters in the extracted license plate characters into a format which prevents recreation of the extracted license plate characters. In another aspect, storing includes indexing, by the data storage module, data in the anonymized license plate files based upon parameters including time, location or camera ID. In another aspect, analyzing the anonymized license plate files includes providing the anonymized license plate files to at least one machine learning model and identifying, based upon an output of the at least one machine learning model, the traffic condition. In still another aspect, analyzing the anonymized license plate files includes receiving, from at least one external data source, external data representing at least one of a current weather condition, a public transportation schedule or special event information. Another aspect of this embodiment further comprises outputting by the data analysis module, a notification regarding the traffic condition to a user interface via a second network. In another aspect, the traffic condition includes a traffic volume, a traffic pattern, or a traffic anomaly. In still another aspect, the component of the traffic management infrastructure is a traffic signal and the aspect adjusted is a timing of operation of the traffic signal.

In another embodiment of the present disclosure, a traffic analysis system is provided, comprising: a plurality of cameras, each camera of the plurality of cameras being configured to capture images of license plates on vehicles passing the camera and convert the images into license plate data including license plate characters; a central server coupled to the plurality of cameras via a first network, the central server including a data collection module, a data anonymization module, a data storage module and a data analysis module; and a traffic management component coupled to the central server via a second network; wherein the data collection module is configured to receive the license plate data from the plurality of cameras and package the license plate characters in license plate files; wherein the anonymization module is configured to anonymize the license plate files; and wherein the data analysis module is configured to analyze the anonymized license plate files to identify a traffic condition and output at least one command to the traffic management component, thereby causing the component to adjust an aspect of traffic management based upon the identified traffic condition. In one aspect of this embodiment, the data collection module is coupled to the plurality of cameras via the first network to receive the images in near real-time. In another aspect, the data collection module is further configured to extract timestamp data, vehicle type data and camera ID data from the images. In still another aspect, the anonymization module is configured to transform characters in the extracted license plate characters into a format which prevents recreation of the extracted license plate characters. In another aspect, the central server further includes at least one machine learning model configured to receive the anonymized license plate files and provide an output the data analysis module uses to identify the traffic condition. In yet another aspect, the data analysis module is further configured to receive, from at least one external data source, external data representing at least one of a current weather condition, a public transportation schedule or special event information. In another aspect of this embodiment, the traffic management component is a traffic signal and the aspect adjusted is a timing of operation of the traffic signal.

In another embodiment, the present disclosure provides a method for analyzing traffic, comprising: capturing images of vehicle license plates using a plurality of cameras and converting the images into license plate data including license plate characters; transmitting the license plate data via a first network to a central server having a data collection module, a data anonymization module, a data storage module and a data analysis module; extracting, by the data collection module, the license plate characters from the license plate data; packaging, by the data collection module, the license plate characters in license plate files; anonymizing, by the anonymization module, the license plate files; storing, by the data storage module, the anonymized license plate files; analyzing, by the data analysis module, the anonymized license plate files to identify a traffic condition; and outputting, by the data analysis module, a notification regarding the traffic condition to at least one user interface.

In yet another embodiment, the present disclosure provides a method for fused traffic analysis and responsive querying, comprising: receiving first traffic data (e.g., from license plate cameras or sensors) at a central or distributed server; receiving second traffic data from external sources (e.g., signal sensors or third-party feeds); merging the datasets into a combined traffic dataset via data alignment algorithms (e.g., temporal and spatial overlay); analyzing the combined dataset using predictive models to identify conditions such as cross-jurisdictional flows or anomalies; receiving a user inquiry via an interface (e.g., natural language query); determining an answer or command based on the analysis; and outputting the answer, dataset, or command to the interface or infrastructure. Aspects include exporting merged data to external devices, flagging multi-source anomalies differently (e.g., sensor failures vs. events), and scaling across geographic boundaries, as further detailed in the description.

While multiple embodiments are disclosed, still other embodiments of the disclosure will become apparent to those skilled in the art from the following detailed description. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a conceptual diagram depicting aspects of a prior art system for monitoring traffic;

FIG. 2 is a flow chart depicting a method corresponding to the system depicted in FIG. 1;

FIG. 3 is a conceptual diagram depicting aspects of a system for analyzing traffic information according to the present disclosure; and

FIG. 4 is a flow chart depicting a method corresponding to the system depicted in FIG. 3.

FIG. 5 is a diagram of a user interface used on the system depicted in FIG. 3.

FIG. 6 is a diagram of a trip module used on the user interface used depicted in FIG. 5.

FIG. 7 is a diagram of an anomaly module used on the user interface depicted in FIG. 5.

FIG. 8 is a flow chart depicting another method corresponding to the system depicted in FIG. 3.

FIG. 9 is a diagram of another example of the user interface depicted in FIG. 5.

FIG. 10 is a diagram of a further example of the user interface depicted in FIG. 5.

While the present disclosure is amenable to various modifications and alternative forms, specific embodiments have been shown by way of example in the drawings and are described in detail below. The present disclosure, however, is not limited to the particular embodiments described. On the contrary, the present disclosure is intended to cover all modifications, equivalents, and alternatives falling within the scope of the appended clauses and claims.

### DETAILED DESCRIPTION OF EMBODIMENTS OF THE DISCLOSURE

To provide an overview, the systems and methods of the present disclosure fill the critical need for more robust, efficient, and cost-effective traffic data collection and analysis. Despite the ubiquity of law enforcement license plate cameras, their potential for comprehensive traffic analysis remains untapped. The teachings of the present disclosure repurpose these cameras to collect and provide analyzed granular, per-vehicle traffic data in real-time and retrospectively.

In certain embodiments, the present disclosure addresses the difficulty in accessing real-time traffic data and long-term traffic trends to enable immediate responses to traffic anomalies and facilitate more accurate planning and forecasting by traffic engineers and planners. In other embodiments, the present disclosure offers a solution to the high costs and time associated with traditional traffic data collection by reducing the amount of additional data required.

In a basic embodiment, the present disclosure provides a data collection and analysis system that utilizes existing license plate cameras deployed by law enforcement. As is further described below, the basic embodiment includes a data collection module that interfaces with the license plate cameras to collect per-vehicle data, including timestamped license plate numbers converted by the license plate cameras from images of the license plates. This embodiment further includes a database storage module and central database configured to store the collected data in a structured and retrievable format. Finally, the basic embodiment includes a data analysis module including algorithms for determining traffic volumes, identifying patterns and calculating travel times between two points using the collected timestamps. These core functional components continuously collect and store data from each license plate camera, and then analyze the data to yield actionable traffic insights as is further described below. While the basic embodiment does not include real-time alerts or advanced analytics, it nonetheless provides the foundation for performing traffic analysis and planning tasks.

In other, more comprehensive embodiments, the present disclosure provides real-time traffic anomaly alerts using predictive algorithms to identify traffic pattern anomalies, such as sudden traffic congestion, and communications infrastructure to alert transportation engineers and planners and law enforcement, enabling them to take immediate corrective actions. Moreover, in such comprehensive embodiments the present disclosure may be integrated with existing traffic management systems to automatically adjust the timing characteristics of traffic signals, for example, based on the analyzed data, thereby improving traffic flow efficiency. In certain embodiments, the data is analyzed using machine learning algorithms which identify and predict traffic trends to permit more accurate traffic forecasting and proactive traffic management. In any of these various embodiments, the system of the present disclosure may provide enhanced privacy by incorporating advanced encryption or anonymization techniques to prevent access to a vehicle owner's license plate information while still permitting the traffic analysis described herein.

Other aspects of embodiments of the present disclosure relate to access to the analyzed data. For example, data visualization tools may be included to graphically represent traffic patterns or provide interactive charts and/or graphs, making the data more accessible and understandable for transportation engineers and others. In another example, the data could be made available to third-party developers through an Application Programming Interface (“API”) for use in creating related applications of services. Finally, a public user interface may be included to provide realtime traffic updates to the general public, helping individuals plan their commutes or other travel more effectively.

The most complete embodiment of this disclosure is a comprehensive, intelligent traffic data collection and analysis system. This system capitalizes on the existing network of law enforcement license plate cameras to gather, store, and evaluate real-time and historical per-vehicle traffic data as is further described below.

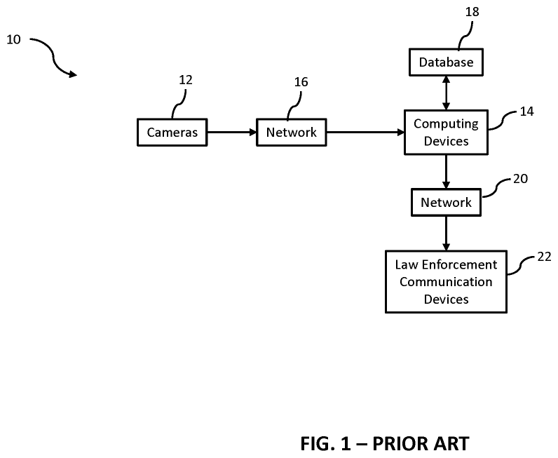

Referring now to FIG. 1, a prior art system for collecting and analyzing vehicle information is shown. System 10 includes a plurality of motion-sensitive, high-speed traffic cameras 12 which are located at various places, sometime temporarily, along certain streets, roads, highways, etc. Such cameras 12 are provided by various law enforcement agencies to capture timestamped images of license plates of vehicles to identify one or more vehicles associated with a person of interest (“POI”) and/or one or more stolen vehicles or a vehicle of interest (“VOI”). At present, it is estimated that over 52,000 cameras 12 are deployed across the United States. The cameras 12 are connected to a plurality of law enforcement computing devices 14 (only one shown) via one or more networks 16 (only one shown). In this manner, each time a camera 12 captures an image of a license plate, the camera 12 timestamps the image, converts the image of the license plate to characters using, for example, optical character recognition software, and transmits the timestamped license plate characters, along with the vehicle type and camera location over the network 16 to the computing devices 14.

Conventionally, the computing devices 14 compare the license plate characters to license plate characters stored in one or more databases 18 in communication with the computing devices 14. The license plate characters stored in the database 18 may include license plate characters associated with POIs in one or more criminal investigations or license plate characters associated VOIs, etc. (collectively referred to herein as “license plate characters of interest or ‘LPCOIs’”). If the computing devices 14 identify a match between a license plate character from an image taken by a particular camera 12 and an LPCOI in the database 18, then the computing device 14 may conclude that it is likely that a POI is in a vehicle from which the license plate image was obtained or a VOI has been identified at a particular location (i.e., the location corresponding to the camera 12 from which the license plate image was sent) at a particular time (i.e., the time corresponding to the timestamp associated with the license plate image), and traveling in a particular direction (i.e., a direction discerned from the known orientation of the camera 12). The system 10 further includes a second network 20 in communication with the computing devices 14 and a plurality of law enforcement communication devices 22. If the computing devices 14 identify a match as described above, then the computing devices 14 may transmit a notification over the network 20 to the law enforcement communication devices 22 to inform the law enforcement personnel associated with the law enforcement communication devices 22 that a POI and/or a VOI was likely traveling in a particular direction on a particular street at a particular time. The law enforcement personnel may use this information to track down the POI and/or the VOI.

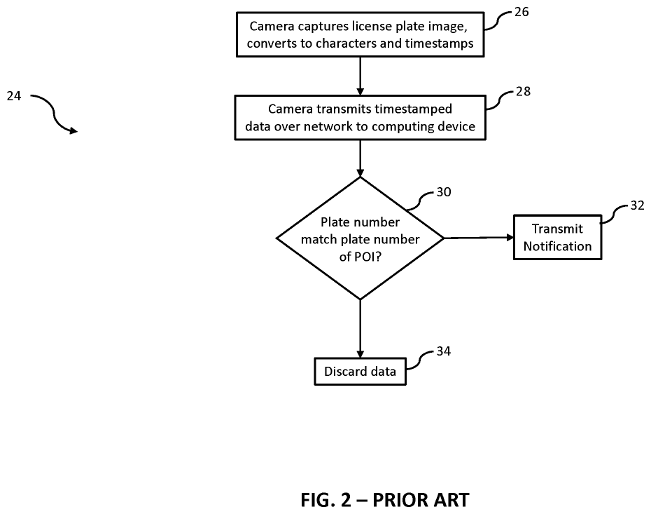

Referring now to FIG. 2, a prior art method 24 carried out by the system 10 of FIG. 1 is shown. At step 26, the plurality of cameras 12 capture images of license plates on vehicles traveling past the cameras 12, converts the license plate images to license plate numbers, and timestamps the images. At step 28, the cameras 12 transmit the timestamped license plate characters along with the vehicle type and camera location over the network 16 to the computing devices 14. At step 30, the computing devices 14 compare the license plate characters to LPCOIs stored in the one or more databases 18 to determine whether a captured license plate character matches an LPCOI stored in the database 18. If a captured plate character matches an LPCOI, then at step 32 the computing devices 14 transmit a notification over the network 20 to the law enforcement communication devices 22 as described above. Otherwise, the data associated with the non-matching license plate number is discarded at step 34.

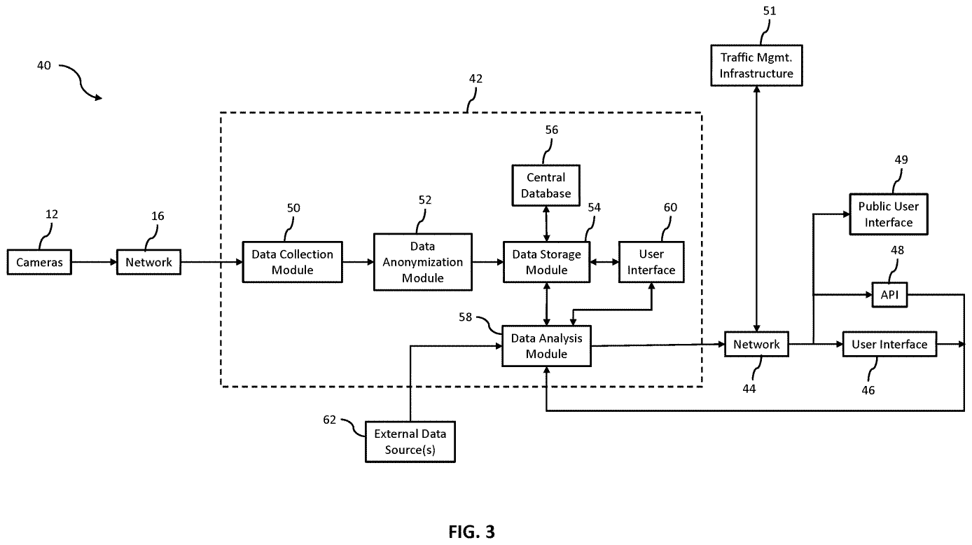

Referring now to FIG. 3, one embodiment of an advanced traffic data analysis system is depicted. System 40 generally includes a plurality of motion-sensitive, high-speed cameras 12 as described above with reference to FIG. 1, a first network 16 connected to the cameras 12, a central server 42, a second network 44, a user interface 46, an API 48, a public user interface 49 and one or more external data sources 62. The central server 42 generally includes a data collection module 50, a data anonymization module 52, a data storage module 54, a central database 56, a data analysis module 58 and a user interface 60.

The cameras 12 can include any type of license plate recognition (LPR) or automated license plate recognition (ALPR) camera deployed for any purpose. In some cases, the cameras 12 include cameras that are operated by law enforcement agencies. However, the cameras 12 are not limited to cameras operated by law enforcement agencies. In one example, the cameras 12 can be operated by municipal transportation departments, toll authorities, parking management agencies, private entities, academic institutions, and/or any other organization that deploys LPR or ALPR technology. In another example, the cameras 12 can include cameras deployed specifically for traffic monitoring, parking enforcement, border control, and/or commercial fleet management, regardless of whether any law enforcement function is associated with the deployment. For instance, the cameras 12 can include cameras deployed for municipal, community, and/or general public safety purposes. The system 40 is compatible with any network of cameras or sensors capable of producing vehicle passage records, and the identity or mission of the entity operating those cameras does not affect the ability of the system 40 to collect, anonymize, and analyze the resulting data. Accordingly, references to “law enforcement” cameras herein are illustrative of one deployment context, and are not intended to limit the scope of the system 40 or the methods described herein. Further, as should be appreciated, the system 40 can include any type of sensors in addition to or in place of the cameras 12.

As indicated above, the cameras 12 capture images of vehicle license plates in real-time as vehicles pass the cameras 12. As the license plate images are captured, they are converted to license plate characters, timestamped and transmitted to the central server 42 over the network 16 in near real-time. The vehicle type (e.g., motorcycle, car, truck, bus, etc.) and the camera location is also transmitted. The first network 16 may include one or more networks that facilitate communications between the cameras 12 and the central server 42. The first network 16 may be a wireless network, a wired network, or a combination of both.

In one version, optical character recognition (OCR) or other character extraction processing is performed by the cameras 12, such as through one or more processors and/or computers in the camera 12. In this version, the cameras 12 can output license plate characters directly. In another version, the cameras 12 can transmit raw image data, video frames, and/or image event streams to the central server 42 or to an intermediate processing node. The data collection module 50 and/or another part of the central server 42 can perform the character extraction. In yet another version, OCR processing can be distributed across both the cameras 12 and the central server 42. For instance, initial processing can be performed at the camera 12 and refinement or validation can be performed at the server 42. The system 40 is compatible with all such configurations, and the data collection module 50 can be configured to receive either pre-converted license plate characters or raw image data from which characters are subsequently extracted. The system 40 therefore is adaptable to use various types of cameras 12 having different capabilities and to meet various requirements of camera deployment.

The data collection module 50 includes hardware and software configured to receive the incoming license plate characters from the network 16. The data collection module 50 packages the identified characters in a license plate file corresponding to the license plate image. The data collection module 50 also identifies the particular camera 12 associated with an incoming license plate image from a camera ID provided with the image, and includes the camera ID in the license plate file. Thus, the central server 42 may determine the location and direction of travel of a vehicle corresponding to the captured license plate as is further described below. Finally, the data collection module 50 is configured to extract the timestamp from each incoming license plate image from metadata associated with the image at the time of its creation by the corresponding camera 12. The timestamp is also included in the license plate file.

The data collection module 50 can organize the data associated with each vehicle detection into any suitable data structure, including but not limited to files, database records, streaming event objects, in-memory objects, JSON or XML documents, protocol buffer messages, or entries in a relational or non-relational datastore. The license plate files and the vehicle passage records in the system 40 can include any such data structure that associates a vehicle passage identifier with one or more of a timestamp, a camera or sensor identifier, a geographic location, a direction of travel, and/or a vehicle classification, regardless of the format or storage mechanism used. In one example, the data collection module 50 can store vehicle detection data as records in a relational database in real-time as detections are received. In another example, the data collection module 50 can package detection data as streaming event objects transmitted to a message queue or event bus for downstream processing by the data analysis module 58. The system 40 can operate using any such data organization approach without departing from the scope of the methods and systems described herein.

In further embodiments, the plurality of cameras 12 may be supplemented or replaced by other sensors such as radar detectors for speed/occupancy, LiDAR for trajectories, inductive loops for volume, or GPS feeds from connected vehicles. The data collection module 50 unifies such data into vehicle passage records with timestamps, sensor IDs, and anonymized identifiers (e.g., hashed signatures), enabling analysis without optical reliance. Alternatively, third-party feeds provide pre-processed records, making the system agnostic to data origin while tying to original LPR pipeline for fallback.

In further embodiments, the data collection module 50 is configured to receive traffic data from sources beyond license plate cameras 12, thereby enhancing the system's versatility and robustness. For example, the module 50 may interface with additional sensors such as radar detectors, LiDAR units, inductive loop detectors embedded in roadways, or GPS data feeds from connected vehicles or mobile applications. These alternative data sources provide complementary information, including vehicle speed, occupancy, or trajectory, without relying on optical character recognition of license plates. The data collection module 50 packages such data into unified files analogous to the license plate files described above, including timestamps, sensor IDs, and anonymized identifiers (e.g., hashed vehicle signatures). This multi-modal approach allows the system 40 to operate in environments where ALPR is infeasible, such as low-light conditions or non-vehicle traffic (e.g., pedestrians via computer vision). Integration with these sources is achieved via standardized protocols like MQTT or RESTful APIs over the network 16, ensuring seamless fusion with license plate data in the central database 56 for comprehensive analysis by the data analysis module 58, as depicted in FIG. 3.

In certain embodiments, the data collection module 50 can be configured to receive vehicle passage records or detection events that originate from a third-party LPR or ALPR system, a third-party traffic management platform, or a data aggregator, rather than directly from cameras 12 communicatively connected to the system 40. In such embodiments, the central server 42 can receive pre-processed detection records that include a vehicle passage identifier, a timestamp, and a sensor location identifier, without receiving raw image data or performing OCR processing. The data analysis module 58 can perform all described analytics functions using such pre-processed records in the same manner as it operates on records generated by the data collection module 50 from directly connected cameras 12. This architecture allows the system 40 to serve as an analytics and traffic management platform that is agnostic to the upstream source of vehicle passage data. Using such an adaptable architecture can allow the system 40 to integrate with a wide variety of existing LPR or ALPR deployments regardless of the hardware, software, or entity responsible for those deployments.

The data collection module 50 is configured to be compatible with any of the plurality of cameras 12 and data formats used by the cameras 12. The data collection module 50 includes software that connects, via the network 16, to the APIs and data output streams of the cameras 12, accommodating the various data protocols and formats. The data collection module 50 may be configured to access the license plate image data from the cameras 12 in near real-time, on a fixed access schedule or, alternatively, on demand depending upon the application. In certain applications, substantially constant access to the incoming license plate data streams may be desirable, whereas in other applications periodic access (e.g., every minute, every hour, every day, etc.) may be sufficient. In certain embodiments, the data collection module 50 is configured to be modified as necessary to maintain compatibility with new models of cameras 12 or upgrades to existing camera systems.

The data anonymization module 52 is configured to encrypt and/or anonymize the information included in the license plate files generated by the data collection module 50. As should be apparent to those skilled in the art, a variety of potential privacy issues may be implicated by the collection and transmission of license plate information that includes the timestamped location and direction of travel of the vehicle having the captured license plate. As such, the system 40 of the present disclosure via the data anonymization module 52 incorporates encryption and anonymization techniques that protect the privacy of individual drivers while still permitting analysis and use of the underlying traffic data. In certain embodiments, all license plate data received by the data anonymization module 52 (i.e., all license plate files) is encrypted before transmission over the network 16 to ensure that it remains secure during processing by the central server 42. In certain embodiments, the encrypted license plate data is transmitted over secure, encrypted communication channels represented by the network 16. In any of such embodiments, the encryption keys may be tightly controlled and accessible only to authorized personnel.

In one example, the data anonymization module 52 can transform raw license plate characters into a non-reversible identifier, such as a cryptographic hash, a salted hash, an HMAC token, and/or another privacy-preserving token, prior to any further processing or storage. In such an implementation, the system 40 can correlate vehicle detections across multiple cameras 12 using the non-reversible identifier without retaining or processing the original license plate characters at any stage downstream of the anonymization module 52. In another example, the data anonymization module 52 applies a consistent, deterministic transformation such that the same license plate characters captured at different camera locations and at different times will produce the same non-reversible identifier, enabling the data analysis module 58 to track vehicle passages across the camera network without exposing or retaining the underlying plate characters. In this manner, the system 40 can perform all described analytics functions, including travel time calculation, origin-destination analysis, corridor analysis, and anomaly detection as some examples, using only non-reversible identifiers. Using such non-reversible identifiers can ensure that the original license plate characters cannot be reconstructed from the stored data. The system 40 can utilize vehicle passage identifiers that include such non-reversible identifiers. In some examples, the vehicle passage identifiers can be functionally equivalent to license plate characters for the purpose of the analyses described herein.

The anonymization module 52 is configured to transform the characters in the license plate files received from the data collection module 50 into an unidentifiable format that prevents recreation of the actual sequence of characters corresponding to the license plate originally captured by a camera 12. As such, the system 40 is compliant with the relevant privacy laws and regulations, including GDPR, CCPA and other regional and national data protection standards. In addition to anonymizing the license plate data, the anonymization module 52 is configured to mask or remove other potentially identifying information from the license plate files before storage or analysis by the central server 42. It should be understood, however, that in situations where law enforcement requires access to the original license plate data for legal purposes, the system 40 may incorporate methods to reverse the anonymization.

To further enhance privacy protections and ensure global compliance, the data anonymization module 52 may incorporate advanced techniques beyond character transformation. For instance, differential privacy mechanisms add calibrated noise to aggregated datasets, preventing re-identification while preserving statistical utility for analysis. Blockchain-based logging records anonymization processes immutably, providing audit trails for regulatory compliance (e.g., under the EU AI Act or U.S. state privacy laws beyond CCPA). In international embodiments, the module 52 adapts to regional variations, such as handling non-alphanumeric license plates (e.g., in Europe or Asia) via locale-specific hashing algorithms or supporting multilingual OCR for diverse vehicle registrations. Reversible anonymization for law enforcement is secured via multi-factor access controls or homomorphic encryption, allowing computations on encrypted data without decryption. These enhancements ensure the system 40 operates ethically across jurisdictions, with the anonymized files seamlessly interfacing with the data storage module 54 for secure querying.

The data storage module 54 receives the anonymized license plate files from the anonymization module 52. The data storage module 54, along with the central database 56, provides a database system designed to store the collected data in a structured and retrievable format. The data storage module 54 is configured to store the data included in the license plate files in a structure based on a relational database model, where the data is stored in tables with defined relationships in the central database 56. Each entry in the central database 56 includes data points such as license plate numbers (as anonymized by the anonymization module 52), timestamps, camera IDs and geographical coordinates of the camera 12, all organized in a manner to facilitate correlation and analysis. To enhance retrievability of the data by the data analysis module 58, the data is indexed based on parameters such as time, location and unique identifiers. This indexing allows for quick and efficient querying of the database 56, enabling users to retrieve specific data subsets based on their analytical needs. Moreover, the central database 56 is designed to be scalable, and is capable of accommodating large quantities of data that accumulate over time from the plurality of cameras 12. In some embodiments, the data storage module 54 may be in communication with the user interface 60 of the central server 42 which may be used to perform complex queries and data retrieval operations that support various analytical tasks and reports generated by end users. Finally, it should be understood that the central database 56 is configured to adhere to strict data security protocols and to comply with relevant privacy regulations. As such, access control, encryption and regular security audits may be used to safeguard the data stored in central database 56.

The data analysis module 58 performs a variety of functions by accessing the anonymized data in the central database 56. At a high level, the data analysis module 58 identifies traffic trends, calculates travel times of individual vehicles, predicts traffic flows and volumes, provides real-time traffic information and generates alerts or notifications of traffic anomalies. The data analysis module 58 is configured to provide the output of these analyses (i.e., real-time information, forecasts, reports, etc.) to the user interface 60 and/or the user interface 46, the API 48 and/or the public user interface 49 via the network 44. In this manner, the data analysis module 58 may, among other things, permit traffic managers to swiftly respond to anomalies in traffic volume or patterns. In addition or alternatively, the output of the analyses of the data analysis module 58 may be routed to a user interface 46 that is in communication with or operated by emergency response personnel to provide information about potential accidents and/or to recommended routes for emergency responses based on traffic conditions and historical data. Moreover, the outputs of the data analysis module 58 may be directly integrated with various traffic management systems to permit real-time adjustments to traffic signals as is further described below.

The data analysis module 58 can produce outputs that encompass a broad range of traffic intelligence products, not limited to commands directed to traffic management infrastructure 51. In one example, the data analysis module 58 can generate travel time estimates and travel time distributions for defined corridors or origin-destination pairs based on the timestamps associated with vehicle passage identifiers observed at multiple camera locations. In another example, the data analysis module 58 can compute origin-destination matrices that characterize the movement of vehicles between geographic zones covered by the camera network, providing input for regional transportation planning. In another example, the data analysis module 58 can generate exports of combined traffic datasets, including both data collected by the cameras 12 and external data received from the external data sources 62, formatted for consumption by third-party analysis platforms or export to external devices via the API 48. In yet another example, the data analysis module 58 can generate reports, dashboards, or structured data feeds that characterize traffic volumes, speed estimates, queue lengths, turning movements, or vehicle classification distributions at individual camera locations or across groups of locations. These outputs can be delivered to the user interface 46, the public user interface 49, the API 48, or to external systems, independently of whether any command to traffic management infrastructure 51 is generated. The system 40 thus provides value across a full spectrum of use cases, from real-time signal control to long-term infrastructure planning and third-party data integration, through a common underlying data collection and analytics pipeline.

The basic functions performed by the data analysis module 58 may be summarized as determining traffic volumes and identifying traffic patterns. To determine traffic volumes, the data analysis module 58 accesses the data in the central database 56 to count the number of vehicles (using the anonymized license plate data) that pass through a specific point or area (covered by one or more cameras 12) within a given timeframe (using the associated timestamps). The data analysis module 58 may use the resulting traffic volume determinations to compute traffic volume variations over different times of day, different days of the week, different times of the year, or other relevant time periods. In this manner, the data analysis module 58 may identify peak traffic hours and other periods of relatively low traffic activity. In other embodiments, the data analysis module 58 combines the traffic volume data with geospatial information from the cameras 12 to provide a spatial understanding of traffic volume across different parts of a city or region. This analysis may be useful to public agencies responsible for urban planning, infrastructure development and/or public transportation. For example, such agencies may make decisions about future projects with insights provided by the system 40 regarding the environmental impact of traffic, such as pollution levels and noise.

To identify traffic patterns, trends and anomalies, the data analysis module 58 employs machine learning techniques. The patterns may be related to vehicle flow, congestion points and typical traffic behaviors. The data analysis module 58 may also use historical data in the central database 56 to predict future traffic trends, thereby aiding in proactive traffic management and planning. For example, if a congestion or bottleneck is predicted for a future time at a particular location, then traffic engineers may take preemptive measures to mitigate the severity of such a traffic jam. The machine learning models of the data analysis module 58 are trained on historical traffic data collected by the system 40. After sufficient training, the models learn typical traffic patterns including peak hours, normal flow variations and regular congestion points. The models are designed to continuously learn and improve over time as new traffic information is collected from license plate data as is further described herein. In this manner, the system 40 can forecast traffic conditions for a particular time or traffic situation.

In certain embodiments, the data analysis module 58 is configured to receive a query or inquiry from a user via the user interface 46, the user interface 60, or the API 48, and to determine a responsive output based on analysis of the traffic data stored in the central database 56 and any combined traffic dataset assembled from external data sources 62. In one example, the inquiry can be submitted in natural language, and the data analysis module 58 can use natural language processing techniques to interpret the inquiry and identify the relevant data and analyses needed to formulate a response. In another example, the inquiry can be submitted in a structured format, such as through a form-based interface or a programmatic API call. The response generated by the data analysis module 58 can include a descriptive answer, a data export, a forecast, a recommendation for traffic management actions, or a direct command to a component of traffic management infrastructure 51, depending on the nature of the inquiry and the configuration of the system 40. In this manner, the responsive querying capability of the system 40 can make advanced traffic analytics accessible to users with varying levels of technical expertise and can support both operational decision-making and strategic planning functions.

The historical data may also be used to identify traffic anomalies in real-time. For example, the data analysis module 58 may compare current traffic conditions (e.g., current traffic flow) at a particular location to historical traffic conditions at that location to identify unusual or anomalous traffic flow (e.g., sudden increases or decreases) in real-time. The data analysis module 58 may then generate an alert or notification for transmission via the network 44 to the user interface 46, thereby alerting transportation engineers, for example, of a current traffic anomaly. In some circumstances, the transportation engineers may adjust traffic light timing, issue travel advisories, or deploy resources such as traffic control personnel, for example, to address the traffic anomaly. This information is provided as feedback to the data analysis module 58 for further training of the machine learning models to improve the accuracy of the predictions generated by the models.

In certain embodiments, supervised machine learning models are used by the data analysis module 58. These models use labeled traffic data to learn the relationship between input variables (e.g., time of day, time of year, location, weather conditions, etc. as is described herein) and the outcome (such as traffic volume or congestion levels). In other embodiments, the data analysis module 58 uses unsupervised machine learning models which analyze unlabeled data to find hidden structures or patterns in traffic data without pre-assigned categories or labels. In still other embodiments, the data analysis module 58 employs reinforcement machine learning models which use a trial-and-error approach to find optimal strategies for traffic management, learning from the outcomes of previous actions. In other embodiments, a mixture of some or all of the previously mentioned machine learning models is used.

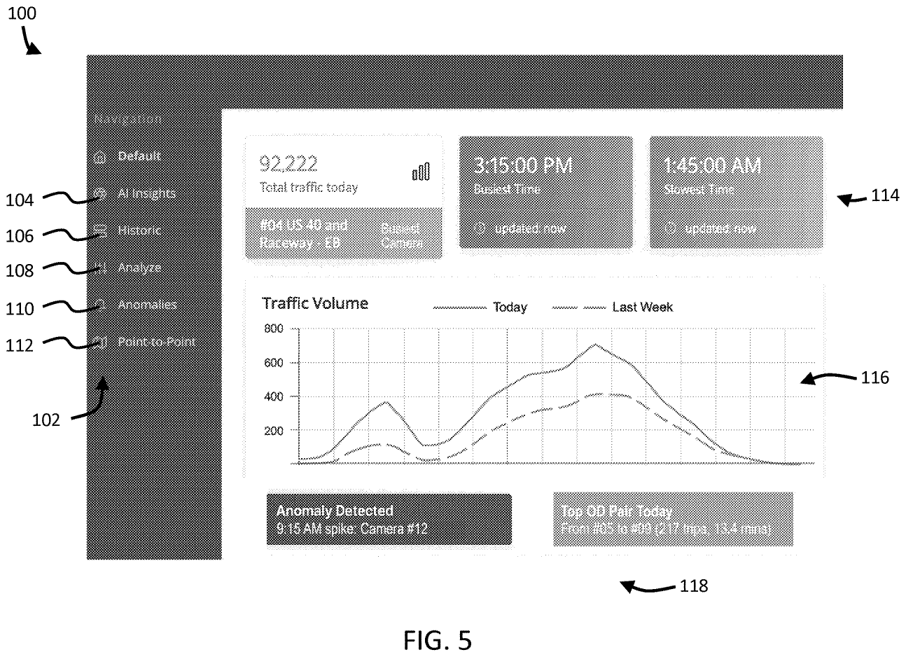

The machine learning models employed by the data analysis module 58 may encompass a variety of advanced techniques to further broaden the analytical capabilities of the system 40. Beyond supervised, unsupervised, and reinforcement learning, embodiments may incorporate deep neural networks (e.g., convolutional neural networks for pattern recognition in traffic flows) or ensemble methods (e.g., random forests combining multiple models for robust anomaly detection). Training data for these models is derived not only from historical license plate files in the central database 56 but also from synthetic datasets generated via simulations (e.g., traffic modeling software like SUMO) or augmented external data from sources 62, such as weather APIs or event calendars. Model updates occur iteratively, with techniques like transfer learning applied to adapt pre-trained models from one urban area to another, minimizing retraining costs. In certain embodiments, explainable AI components provide interpretable outputs (e.g., feature importance scores for traffic predictions), aiding users in validating analyses via the user interface 100 (FIGS. 5-7). This expanded ML framework enables the system 40 to forecast complex scenarios, such as the cascading effects of autonomous vehicle adoption on traffic patterns.

In alternative embodiments, the data analysis module 58 may use the machine learning models to provide predictions of the impact of changing road conditions such as road closures, new infrastructure, and/or changes in traffic signal timing before such changes are implemented. The data analysis module 58 may provide input data to the machine learning modules that simulates such changes in infrastructure and the models will provide predictions on the impact of the changes. In this manner, the system 40 may be used to test various possible alterations to the traffic network to determine a preferred alteration without implementing any infrastructure change.

In other embodiments, the data analysis module 58 receives external data such as current weather conditions, public transportation schedules and information about special events (e.g., concerts, marathons, etc.) from the one or more external data sources 62 and uses that information along with the traffic information to understand and predict the impact of such conditions and events on traffic flow and patterns. Again, the data analysis module 58 may provide notifications via the network 44 to the user interface 46 to permit traffic engineers and/or law enforcement to anticipate upcoming traffic conditions and take steps to mitigate them. In addition, or alternatively, the data analysis module 58 may provide alerts to the public user interface 49 to notify the general public of predicted traffic conditions so drivers can plan accordingly.

While the embodiments described herein primarily utilize a central server 42 for data processing, alternative configurations employ distributed or edge computing architectures to broaden deployment options and improve latency. For instance, preliminary anonymization and analysis may occur at edge devices proximate to the cameras 12 (e.g., on-site gateways), with only aggregated, anonymized results transmitted to the central server 42 or a cloud-based platform. This edge processing reduces bandwidth demands on the network 16 and enables real-time responses in bandwidth-constrained environments. In federated learning embodiments, machine learning models in the data analysis module 58 are trained across decentralized nodes (e.g., multiple regional servers) without sharing raw data, preserving privacy while aggregating insights from diverse geographic areas. Such distributed systems may leverage cloud services (e.g., AWS IoT or Azure Edge) for scalable storage in the central database 56, allowing the system 40 to handle petabyte-scale data from thousands of sensors across municipalities, as illustrated conceptually in the integration of external data sources 62 in FIG. 3.

Unlike conventional systems such as that depicted in FIG. 1, the system 40 according to embodiments of the present disclosure operates with per-vehicle data, which provides an unprecedented granularity that enhances the precision and depth of the traffic analysis. This per-vehicle data includes individual vehicle movements with timestamps and location information. As a result, the system 40 can analyze each vehicle's behavior and path through the network of roads and streets monitored using the plurality of cameras 12. The data analysis module 58 measures traffic volume in certain embodiments by processing data from various sources (i.e., cameras 12) to accurately measure the volume of traffic passing though different points in the traffic network. Moreover, by analyzing the timestamps associated with images of particular vehicles at different points in the traffic network, the data analysis module 58 may calculate the time taken by the vehicles to travel from point A to point B, for example, which may provide insights for route optimization in the event of a future lane closure or detour. In fact, in certain embodiments where a sufficient number of appropriately located cameras 12 are provided, the system 40 can detect and report on lane usage patterns, preferred routes, average travel times and responses to traffic signals and/or incidents.

As should be apparent from the foregoing, the data analysis module 58 is the source of a wide variety of real-time notifications, recommendations, reports and even direct commands for controlling existing traffic management infrastructure 51 (FIG. 3) such as streetlights. The notifications may be customized based on the severity of the condition giving rise to the notification, the location of the condition and/or the nature of the anomaly. Along with the notifications, the data analysis module 58 may provide real-time recommendations for potential corrective actions to mitigate the traffic condition (e.g., lane closures, recommended alternative routes, street closures, etc.). In this manner, the system 40 permits rapid responses to traffic conditions which may improve public safety and enhance the efficient use of traffic infrastructure.

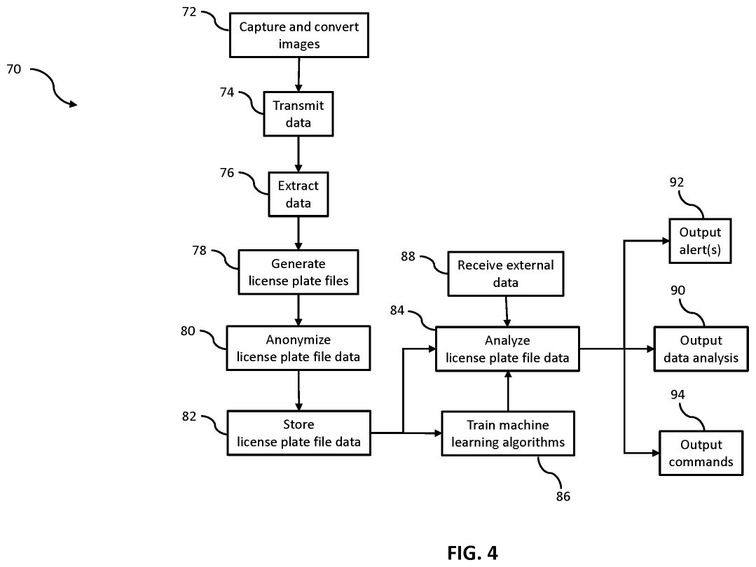

Referring now to FIG. 4, a method of collecting, analyzing and using traffic information is depicted. The method 70 begins at step 72 where the cameras 12 capture images of license plates and convert the images to license plate characters as described above. The cameras 12 include other information with each license plate image, including the camera ID and/or location, vehicle type and a timestamp. At step 74, the license plate characters and the other data are transmitted over the network 16 to the central server 42. The license plate characters may be automatically transmitted substantially simultaneously with its capture by the camera 12, or it may be temporarily stored by the camera 12 until it is accessed by the central server 42. The access by the central server 42 may be periodic on a fixed schedule or based upon an anticipated volume of license plate data captured by the camera 12 given the knowledge of the central server 42 of historic traffic conditions associated with the camera 12. At step 76 the data collection module 50 extracts the license plate characters, timestamps, vehicle type and camera IDs from the images. At step 78 the data collection module 50 packages the extracted data (i.e., the license plate characters, the timestamps, the vehicle type and the camera IDs) into license plate files. The license plate files are provided to the data anonymization module 52, which anonymizes the data in the license plate files as indicated by step 80 and described above. The anonymized license plate data is received by the data storage module 54 and stored in the central database 56 at step 82.

At step 84, the license plate file data is analyzed by the data analysis module 58 to identify traffic trends, calculate travel times of individual vehicles, predict traffic flows and volumes, provide real-time traffic information and generate alerts or notifications of traffic anomalies and/or control traffic management infrastructure 51 depending upon the application. As part of the data analysis, the license plate file data may be provided to machine learning algorithms as training data as depicted in step 86. The outputs of the machine learning algorithms may be used by the data analysis module 58 in the analysis of the license plate file data as described herein. The data analysis module 58 may also receive external data from the one or more external data sources 62 which is used in the analysis of the license plate file data as indicated by step 88.

At step 90, the data analysis module 58 provides the output of these analyses (i.e., real-time information, forecasts, reports, etc.) to the user interface 60 and/or the user interface 46, the API 48 and/or the public user interface 49 via the network 44. In this manner, the data analysis module 58 may, among other things, permit traffic managers to swiftly respond to anomalies in traffic volume or patterns. As described above, the output of the analyses may be routed to the user interface 46 in the form of alerts (step 92) to provide information about potential accidents and/or to recommended routes for emergency responses based on traffic conditions and historical data. The outputs of the data analysis module 58 may also be directly integrated with various traffic management infrastructure 51 to provide real-time commands (step 94) for adjustments to, for example, traffic signals.

The outputs of the data analysis module 58 extend beyond traffic signals to integrate with broader smart city ecosystems, providing actionable intelligence for diverse applications. For example, identified traffic conditions may trigger vehicle-to-everything (V2X) communications, disseminating alerts to connected vehicles (e.g., via DSRC or C-V2X protocols) for dynamic rerouting around anomalies. In environmental monitoring embodiments, the module 58 correlates traffic volumes with emissions models (using vehicle type data) to forecast air quality impacts, outputting recommendations to municipal systems for low-emission zones or EV charging optimizations. Additionally, integration with emergency services allows real-time route optimization for ambulances or fire trucks, prioritizing paths based on predicted delays from the analysis. These expanded outputs are transmitted via the network 44 to APIs 48 or public interfaces 49, enabling third-party applications such as ride-sharing platforms to incorporate system-derived traffic forecasts. Such integrations, as supported by the method 70 in FIG. 4, enhance urban sustainability and public safety without requiring new hardware infrastructure.

FIGS. 5-7 illustrate one example of a user interface 100. The user interface 100 shown in FIGS. 5-7 can be used in the user interface 46, the public user interface 49, and/or the user interface 60. The user interface 100 generally allows users to communicate with the data analysis module 58 to receive analysis outputs, receive data, perform particular types of analysis, and/or send inquiries, as some non-limiting examples. Through the user interface 100, the data analysis module 58 can support a wide range of analysis capabilities and flexibility to users. The user interface 100 allows users to analyze the data in various ways, to overlay various sets of data, to receive real-time updates on traffic conditions, and/or perform other tasks. In some examples, the user interface 100 can be customized for different types of users, such as for city planners, engineers, law enforcement, and/or the general public. In one example, the user interface 100 can provide a simplified display for public users, such as to provide basic traffic updates, and a more complex display for specialized users, such as to allow customized data analysis. As should be appreciated, the user interface 100 can be customizable and adaptable to support various types of tasks.

The systems and methods disclosed herein can incorporate traffic data including data recorded by cameras, traffic conditions computed by the data analysis module over time, various data sets received from one or more external data sources, and/or combinations of different types of data. In one version, the system 40 is configured to utilize any type of traffic data. For example, the system 40 can be configured to utilize traffic data that does not include license plate information and/or is not derived from the cameras 12. As should be appreciated, the data analysis module 58 can perform various types of analysis using various types of traffic data, such as external data from the external data sources 62 and/or data collected within the system 40 that does not include license plate information. The external data from the external data sources 62 can include external traffic data such as information about traffic conditions, vehicle counts, license plate data, and/or other information about vehicles in an area. As some examples, the external traffic data can include license plate data, signal data, crash records, and/or vendor traffic feeds as some examples. The signal data can be collected via sensors at traffic signals, such as induction loops, camera systems, radar sensors, infrared sensors (active/passive), ultrasonic sensors, microwave sensors and/or magnetic sensors (e.g., magnetometers), just to name a few non-limiting examples. The signal data and can indicate lane and/or turn directions of a vehicle, vehicle volumes, stop times, and/or other information about traffic at the traffic signal. As should be appreciated, the external traffic data can be received from a variety of sources. The system 40 can allow users to integrate computed traffic conditions, external traffic data, and/or other types of data into a combined traffic dataset. Integrating various sets of external traffic data can allow users to gain deeper insight into traffic patterns, corroborate data from multiple sources to increase reliability, expand analysis across multiple geographic areas, and/or otherwise prepare a customized dataset to meet user needs.

The systems and methods can be configured to aggregate various types of analysis outputs and/or traffic data. The combined traffic data can include any combination of analysis outputs and traffic data. In one example, the system 40 can be configured to output and/or export the combined traffic dataset to a third party. When exporting the traffic data, the system 40 can anonymize, encrypt, and/or otherwise protect privacy of the traffic data. In one example, the system 40 is configured to process data to remove or anonymize potentially identifying information. For instance, the system 40 can remove or anonymize license plate data from the exported data to ensure that the license plate data is not transferred to third parties. Further, the system 40 can be configured to output the combined traffic data to an external analysis device. For instance, the system 40 can allow a user to export the combined traffic dataset and/or other data via the user interface 100. As should be appreciated, the system 40 is configured to aggregate any combination of traffic data and/or analysis outputs to facilitate subsequent analysis on another device and/or for review by individuals on the user interface 100 and/or another device.

As shown, the user interface 100 can include multiple interface modules 102. Each interface module 102 can be implemented through hardware and/or software on the central server 42. For instance, the interface modules 102 can be implemented through the data analysis module 58. Each interface module 100 can be represented by a tab and/or window on the user interface 100. In one example, the user interface 100 can include an artificial intelligence (AI) module 104, a historic data module 106, an analysis module 108, an anomaly module 110, and a trip module 112. The user interface 100 is further configured to display one or more statuses 114, charts 116, and/or alerts 118. The user interface 100 can display the statuses 114, charts 116, and/or alerts 118 on a home window that provides a high level overview of traffic in the vicinity and provides access to the other interface modules 102. As should be appreciated, the types of interface modules 102 and the information displayed on the user interface 100 can be customizable and/or can be adjusted for different usages. For example, the user interface 48, the public user interface 49, and the user interface 60 on the central server 42 can each utilize a unique set of interface modules 102 and/or provide access to different types of information.

The AI module 104 generally utilizes one or more machine learning models to identify traffic conditions based on the license plate data, previously identified traffic conditions, and/or external traffic data. The historic data module 106 can allow users to view and/or compare current traffic conditions to historic traffic data. The historic traffic data can include previously collected license plate information, previously analyzed traffic conditions, and/or external data showing past conditions. In one example, the data analysis module 58 is configured to utilize the historic data to determine seasonal and/or other temporal adjustment factors. For instance, the data analysis module 58 can use such data to normalize vehicle counts and/or other traffic conditions based on historic data for hourly, daily, weekly, and/or other time intervals. As another example, the historic data module 106 allows users to analyze traffic conditions based on various periods of time, such as hourly, daily, weekly, and/or seasonal periods. The data analysis module 58 can provide time-bucketed analytics to users through the user interface 100 based on such analysis. Further, such historic data can allow the data analysis module 58 to perform various types of planning and forecasting analyses, such as long-term infrastructure planning, traffic condition forecasting, corridor studies, comparing traffic conditions before and after infrastructure changes, and/or capital improvement studies.

The analysis module 108 can allow users to analyze data in a variety of ways, such as performing calculations, comparing different datasets, integrating multiple datasets, forecasting future traffic conditions, and/or predicting impacts of proposed traffic changes as some examples. The anomaly module 110 can allow users to view anomalies and/or potentially anomalous data. Trip module 112 can allow users to analyze information based on geographic locations of the cameras 12 and/or travel between specific pairs of locations. The particular set of interface modules 102 shown in FIG. 5 can be just one example of the interface modules 102 used on the user interface 100. As should be appreciated, the user interface 100 can provide the same functionality in a variety of ways besides using discrete and/or separate interface modules 102.

As noted, machine learning models can be incorporated in a variety of ways in the data analysis module 58 and/or another part of the system 40. In one example, a machine learning model can be used to identify a vehicle type and/or other characteristics of vehicles that are captured by the cameras 12. Identifying the vehicle type can allow the system 40 to track trucks and commercial traffic through an area. As another example, a machine learning model can be used to analyze the anonymized license plate data, such as by computing traffic conditions, identifying trends and patterns, determining the impact of future projects, suggesting new camera locations, determining changes to improve traffic conditions, and/or determining a command for a traffic management infrastructure as some examples. Further, a machine learning model can be used to determine anomalies and distinguish between different types of anomalies, such as identifying a lack of data, emerging patterns, and/or low-volume conditions as some examples. The machine learning model can provide outputs by outputting commands, providing suggestions, flagging data, and/or notifying users about a traffic condition for example. The machine learning model can be configured to automatically analyze the data and/or provide outputs. Alternatively, the machine learning model can be configured to analyze the data and/or provide outputs in response to user inputs. As should be appreciated, the data analysis module 58, the central server 42, and/or other parts of the system 40 can utilize machine learning models in a variety of ways.

In one example, the user interface 100 can allow users to send inquiries to the data analysis module 58. The data analysis module 58 is configured to determine answers to the inquiries and to output the answers to the user interface 100. By receiving inquiries, the data analysis module 58 can help users to quickly gain insight into various aspects of the traffic data and/or to perform customized analysis. Further, by receiving inquiries, the data analysis module 58 can make various types of traffic analysis accessible to professionals with different backgrounds and/or the general public. In one example, the user interface 100 can allow a user to send inquiries and receive answers through a chatbot style interface. The AI module 104 can be configured to receive and process inquiries using one or more machine learning models. For instance, the AI module 104 can be configured to process inquiries using natural language processing and/or other techniques that approximate human conversation. In another example, the user interface 100 can provide a list of inquiry options for users and/or receive inquiries in another form. As should be appreciated, the user interface 100 and the data analysis module 58 can be configured to receive and answer inquiries in a variety of ways.

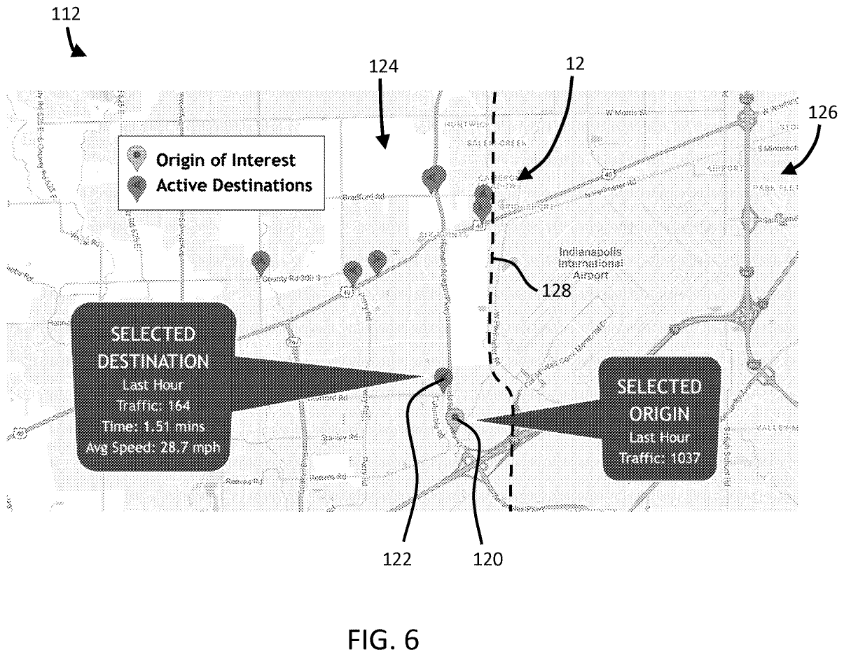

Referring to FIG. 6, the user interface 100 can display a map to users to visualize traffic and/or to allow users to provide specialized inputs. In one example, the user interface 100 can display the map and/or receive such inputs via the trip module 112. The user interface 100 can display the geographic locations of vehicle sensors such as cameras 12 on the map. In one example, the user interface 100 can allow a user to select one or more sensors on the map to analyze traffic conditions based on the locations of the selected sensors. As one example, the user interface 100 can allow a user to select one or more sensors to view metrics and/or analyze data from the sensor(s) 12. As another example, the user interface 100 can allow a user to select multiple sensors to gain insight into the traffic conditions between multiple points on the map. As illustrated, the user interface 100 can allow a user to select an origin location 120 and a destination location 122. Typically, one or more sensors are positioned at each of the origin location 120 and the destination location 122. The data analysis module 58 is configured to analyze trips between the origin location 120 and the destination location 122. The data analysis module 58 can determine one or more traffic conditions between the origin location 120 and the destination location 122, such as travel time, traffic volume, average speed, traffic trends, and/or anomalies as some examples. The data analysis module 58 can determine such traffic conditions based on the anonymized license plate data and/or based on the external data received from one or more external data sources 62.

Further, data analysis module 58 can analyze routes based on locations that are between the origin location 120 and the destination location 122. Such locations can be the geographic locations of other sensors and/or can reflect geographic locations of data that was recorded another way. In one example, the data analysis module 58 can compute and organize data into trip matrices that include traffic conditions for segments between intermediate locations along the route between the origin location 120 and the destination location 122. In another example, the trip matrices can include traffic conditions for different route choices between the origin location 120 and the destination location 122. The data analysis module 58 can therefore analyze choices of different routes between the origin location 120 and the destination location 122.

In one version, the system 40 can be expandable to analyze multiple geographic areas, such as across multiple municipalities, cities, counties, and/or states as examples. The data analysis module 58 can integrate data from multiple geographic areas. As shown, the user interface 100 can display a first area 124 (e.g., home area) and a second area 126 (e.g., an external area) on the map. The first area 124 and the external sensors (e.g., cameras 12) in the system 40 can be located in the first area 124 and the data analysis module 58 can analyze traffic conditions in the first area 124 based on data (e.g., license plate data) captured by the sensors. In that example, the data analysis module 58 can receive information about traffic conditions in the second area 126 from one or more external data sources 62. Alternatively, the data analysis module 58 can receive data (e.g., license plate data) that is captured in the second area 126 and can compute traffic conditions in the second area 126 based on the data. Integrating data from multiple geographic areas allows the system 40 to provide broader insights into travel across boundaries 128 and help coordinate traffic planning between different communities. The user interface 100 can further display traffic information on a shared dashboard that covers multiple communities.

The data analysis module 58 can integrate data from various sources into a combined traffic dataset, such as including data from the first area 124 and from the second area 126. The data analysis module 58 can analyze the combined traffic dataset to compute a traffic condition that spans across the boundary 128. In one example, the data analysis module 58 can track a vehicle trip that spans across the boundary 128. For instance, the data analysis module 58 can compute travel time, traffic volume, average speed, and/or other traffic conditions. In one example, the data analysis module 58 can track the segment of the trip in the first area 124 based on data collected in the first area 124. The data analysis module 58 can track the segment of the trip in the second area 126 based on external data received from the external data source 62. The external data can include license plate data, vehicle counts, signal data, and/or other types of data. In another example, the data analysis module 58 can determine anomalies and/or other conditions that spread across the boundary 128. As should be appreciated, the system 40 can be configured to integrate and analyze data from multiple sources in a variety of ways.

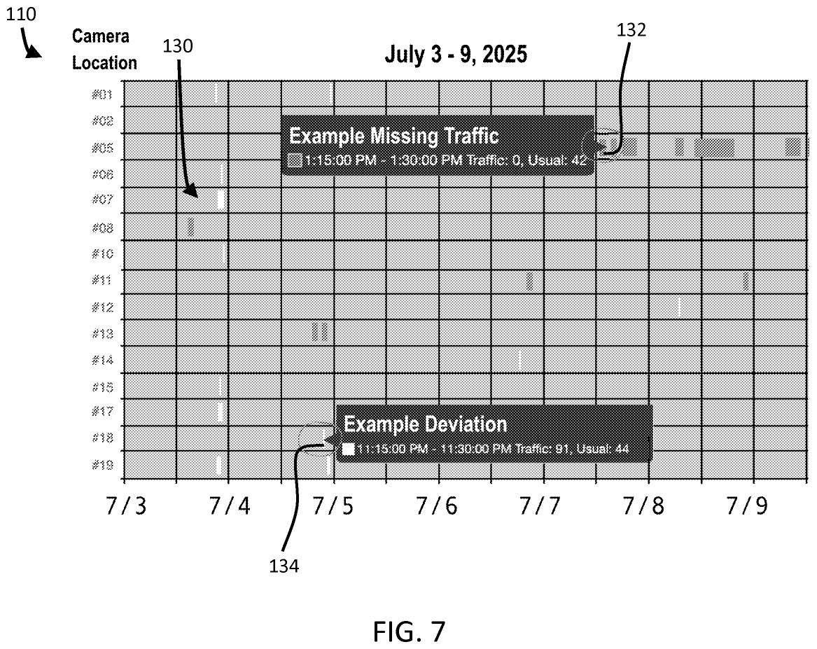

Referring to FIG. 7, the data analysis module 58 is configured to flag anomalies 130 in a variety of ways. In one example, the data analysis module 58 can flag and/or notify users of suspected anomalies 130. In another example, the data analysis module 58 can provide a suggestion to a user and/or send a traffic command in response to an anomaly 130. An anomaly 130 can be associated with one of the sensors (e.g., cameras 12) and with a timestamp. For instance, the data analysis module 58 and/or the data storage module 54 can store the camera 12 that captured data that has been flagged as an anomaly 130 and/or the time that the camera 12 captured that data. The user interface 100 can display information to users about the anomalies 130 in a variety of ways. As some examples, the user interface 100 can display the anomalies 130 on a chart organized by timestamp, can display the anomalies 130 on a chart organized by location and/or the sensor, can display the anomalies 130 on a map, and/or can allow users to customize the way such information is displayed. Further, the data analysis module 58 can allow a user to export data about the anomalies 130.

The data analysis module 58 can distinguish between different types of anomalies 130. In the illustrated example, the data analysis module 58 can identify and flag anomalies of different levels (e.g., priority). For example, the data analysis module may identify and flag anomalies as high-level anomalies 132 and low-level anomalies 134. The high-level anomalies 132 can indicate that one or more parts of the system 40 and/or other equipment may be broken, disconnected, and/or otherwise malfunctioning. In one example, the data analysis module 58 can import data from the external data source 62 that helps provide insight at the location and time that one or more anomalies 130 occurred. For instance, such external data can fill in gaps if one or more cameras 12 failed to capture license plate data for a period. The low-level anomalies 134 can indicate that current traffic conditions are unusual and/or problematic. For instance, low-level anomalies 134 can indicate that traffic is slower than normal, that there is a higher traffic volume than normal, that there is an accident impeding traffic, and/or other such conditions. The data analysis module 58 can send and/or suggest traffic commands to address the anomalies 130.

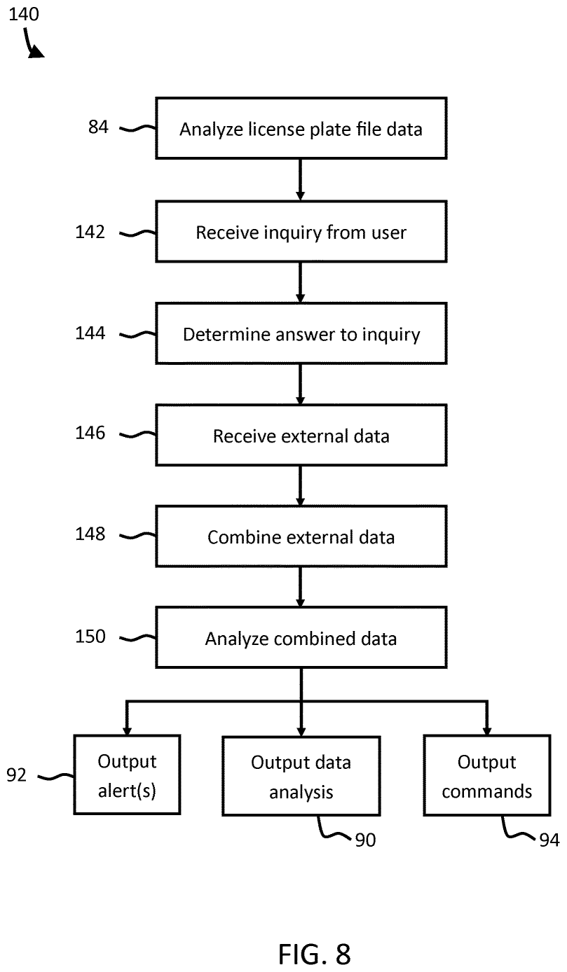

FIG. 8 illustrates a method 140 of collecting, analyzing, and using traffic information. The method 140 can begin at step 84, also shown in FIG. 4. At step 142, the data analysis module 58 can receive an inquiry from a user. Then at step 144, the data analysis module 58 can determine an answer to the inquiry. Receiving and answering inquiries in this way can allow users to easily perform customized analysis of the traffic information.

At step 146, the data analysis module 58 can receive external data from one or more external data sources 62. As noted, the external data can include various types of information. At step 148, the data analysis module 58 can then combine the external data with license plate data, traffic conditions, and/or other data on the central server 42 to form a combined dataset. In some examples, combining the data can include appending and/or overlaying the multiple sets of data. In other examples, the data analysis module 58 can modify one or more values in the data on the central server 42 based on the external data. The data analysis module 58 can then analyze the combined dataset at step 150. After step 150, the data analysis module 58 can then continue to any of step 90, step 92, and step 94, also shown in FIG. 4. As should be appreciated, the order of steps shown in FIG. 8 is just one example of the order the steps can be performed.

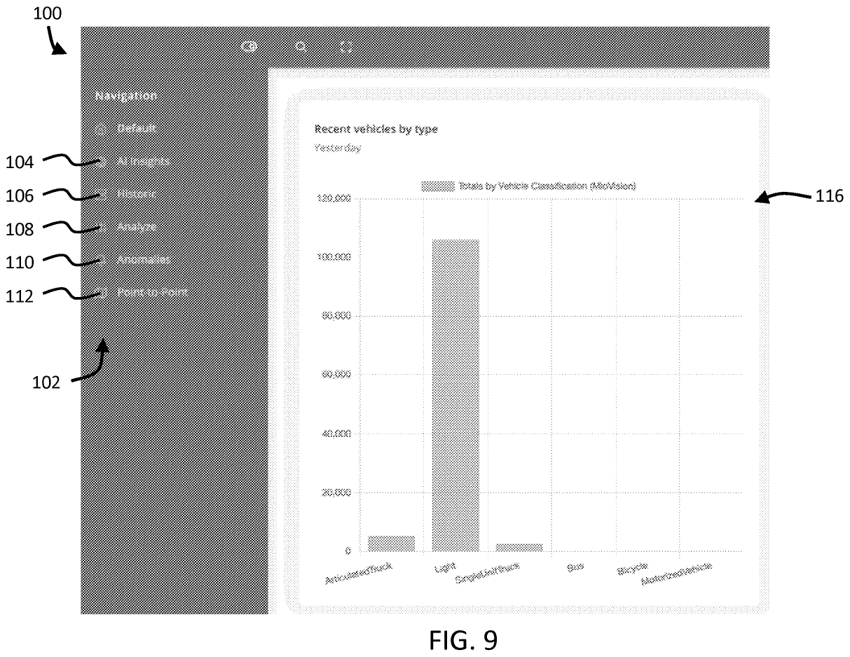

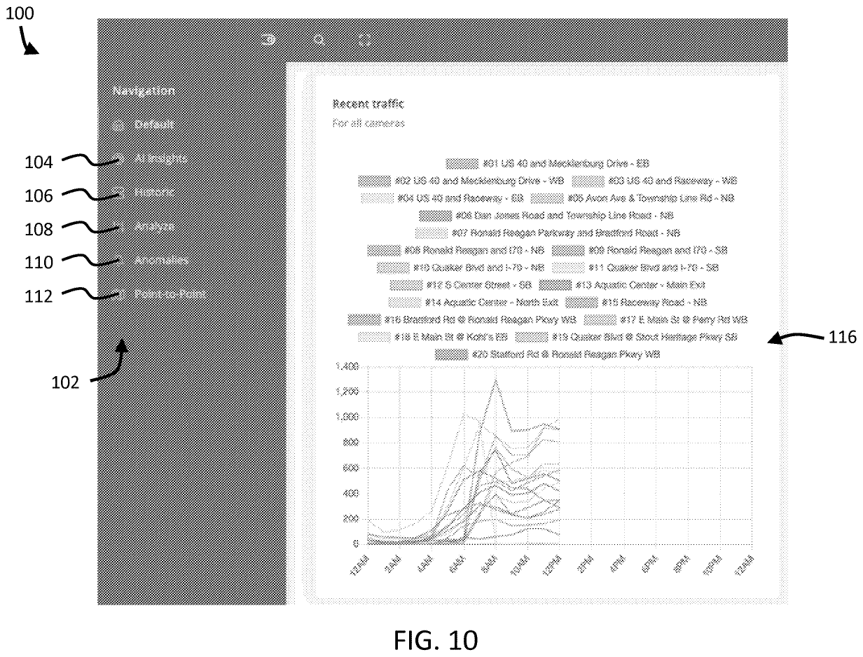

FIGS. 9 and 10 illustrate some further examples of data aggregation and analysis performed by the system 40 and displayed via the user interface 100. The illustrated examples of the user interface 100 represent just a few particular examples of ways that traffic data can be displayed on the user interface 100. As should be appreciated, the system 40 and the user interface 100 can perform various functions related to traffic data and can display traffic data in a wide variety of ways. Further, various parts of the system 40 can process the data to produce the displays and outputs on the user interface 100.

In the FIG. 9 example, the user interface 100 can display a chart 116 that incorporates traffic data from one or more external data sources 62. In the illustrated example, the user interface 100 can display vehicle counts organized by vehicle type. For instance, the user interface 100 can show vehicle counts for vehicle types including articulated trucks, light-duty vehicles, single unit trucks (i.e., truck tractors without trailers), buses, bicycles, and/or miscellaneous motorized vehicles. As one example, the system 40 can combine data collected by sensors 12 in the system 40 with external data from one or more external data sources 62. The external data can include data about the vehicle type. In one example, the system 40 can determine vehicle counts based on anonymous identifiers (e.g., license plate data) and can match anonymous identifiers from the external data to obtain the vehicle type for each vehicle that is counted. Alternatively, the system 40 can incorporate the external data in one or more ways as described previously. Further, the user interface 100 can allow the user to select a time range for the data, such as the previous day, previous hour, weekly average, and/or another time range. As should be appreciated, the user interface 100 can allow users to combine and arrange any number of sets of external data from external data source(s) 62 in a variety of ways.

In the FIG. 10 example, the user interface 100 can display a chart 116 showing real-time traffic data from multiple sources. In one example, the user interface 100 can overlay traffic data from all available sources. Alternatively, the user interface 100 can allow a user to select various sets of traffic data to be overlayed and/or aggregated in other ways in real-time. Combining traffic data in this way can provide users broad insight into current traffic conditions across multiple locations and/or regions.

The data analysis module 58 can allow the user to select data from various locations and/or sources. The selection can include separate datasets for each location, direction of travel, and/or other characteristics. The data analysis module 58 can allow users to select data from various sensors 12. In the illustrated example, the data analysis module 58 allows the user to overlay data from a selection of multiple cameras 12. As some examples, the selection can be all the cameras 12 in a selected geographic region, a customized selection of cameras 12, and/or any other collection of cameras 12. In other examples, the data analysis module 58 allows the user to overlay data collected from a selection of induction loops, radar sensors, infrared sensors, ultrasonic sensors, microwave sensors, magnetic sensors, and/or other types of sensors 12. The data can include vehicle counts and/or any other type of data described herein. In the illustrated example, the traffic data displayed on the chart 116 can indicate recent traffic volumes across the selection of locations. For instance, the chart 116 can include traffic data from the selected sources since the beginning of the day, for the previous few hours, and/or for another range of time. As should be appreciated, the user interface 100 can display any combination of traffic data collected from sensors in the system 40 and/or received from external data sources 62. Further, the user interface 100 can allow users to customize the displayed data based on selections of source, time, and/or any other characteristics.

The system 40 can be deployed across a range of architectural configurations that distribute the functions of data collection, anonymization, storage, and analysis across multiple physical or virtual components. In one example, all functions are performed by a single central server 42 communicatively connected to the cameras 12 via the first network 16. In another example, data collection and anonymization functions are performed by edge computing nodes located proximate to individual cameras 12 or groups of cameras 12, and aggregated anonymized records are transmitted to a central or cloud-hosted server for storage and analysis. In yet another example, individual components of the system 40, such as the data collection module 50, the data anonymization module 52, the data storage module 54, and the data analysis module 58, are implemented as discrete services deployed across separate computing infrastructure, communicatively connected via APIs or message-passing interfaces. The system 40 can also be deployed in a configuration where a first entity operates the cameras 12 and transmits vehicle passage records to a server operated by a second entity, which performs anonymization, storage, and analysis functions. All such configurations, and combinations thereof, are within the scope of the systems and methods described herein. The functional descriptions of the modules herein refer to operations performed by the system 40 as a whole, and do not require that any individual module reside on a single physical device or be operated by a single entity.

Any directional references used with respect to any of the figures, such as right or left, up or down, or top or bottom, are intended for convenience of description, and do not limit the present disclosure or any of its components to any particular positional or spatial orientation. Additionally, any reference to rotation in a clockwise direction or a counter-clockwise direction is simply illustrative. Any such rotation may be implemented in the reverse direction as that described herein.

Although the foregoing text sets forth a detailed description of embodiments of the disclosure, it should be understood that the legal scope of the invention is defined by the words of the claims set forth at the end of this patent and equivalents. The detailed description is to be construed as exemplary only and does not describe every possible embodiment. Numerous alternative embodiments may be implemented, using either current technology or technology developed after the filing date of this patent, which would still fall within the scope of the claims.

The following additional considerations apply to the foregoing description. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different hardware module at a different instance of time.

Modules may provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at various times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single device or geographic location (e.g., within a home environment, an office environment, or a server farm). In other example embodiments, the one or more processors or processor-implemented modules may be distributed across a number of devices or geographic locations.

In addition, the aspects and functionalities described herein may operate over distributed systems (e.g., cloud-based computing systems and/or network-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Unless specifically stated otherwise, use herein of words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Additionally, some embodiments may be described using the expression “communicatively coupled,” which may mean (a) integrated into a single housing, (b) coupled using wires, or (c) coupled wirelessly (i.e., passing data/commands back and forth wirelessly) in various embodiments.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

One of ordinary skill in the art will realize that the embodiments provided can be implemented in hardware, software, firmware, and/or a combination thereof. For example, the controllers disclosed herein may form a portion of a processing subsystem including one or more computing devices having memory, processing, and communication hardware. The controllers may be a single device or a distributed device, and the functions of the controllers may be performed by hardware and/or as computer instructions on a non-transient computer readable storage medium. For example, the computer instructions or programming code in the controller may be implemented in any viable programming language such as C, C++, C #, python, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

As used herein, “traffic condition” includes any measurable aspect of traffic flow, including but not limited to traffic volume, traffic pattern, traffic anomaly, travel time, speed, congestion, or origin-destination matrix, as determined from anonymized vehicle passage data. “Information about vehicle movement” includes data representing vehicle passage, including timestamps, locations, directions, types, or counts derived from sensors.

The following numbered clauses set out specific embodiments that may be useful in understanding the present invention:
Clause 1. A method of controlling traffic management infrastructure, comprising:
   capturing images of vehicle license plates using a plurality of cameras; converting the images to license plate data including license plate characters;
transmitting the license plate data via a first network to a central server having a data collection module, a data anonymization module, a data storage module and a data analysis module;
extracting, by the data collection module, the license plate characters from the license plate data;
packaging, by the data collection module, the license plate characters in license plate files;
anonymizing, by the anonymization module, the license plate files;
   storing, by the data storage module, the anonymized license plate files;
analyzing, by the data analysis module, the anonymized license plate files to identify a traffic condition; and
outputting, by the data analysis module, at least one command to at least one component of traffic management infrastructure, thereby causing the component to adjust an aspect of traffic management based upon the identified traffic condition.

Clause 2. The method of any preceding clause, wherein the plurality of cameras are motion-sensitive, high-speed traffic cameras.

Clause 3. The method of any preceding clause, wherein transmitting the images via the network to the central server occurs in near real-time with the capturing step.

Clause 4. The method of any preceding clause, wherein extracting includes extracting, by the data collection module, timestamp data, vehicle type and camera ID data from the license plate data.

Clause 5. The method of any preceding clause, wherein packaging includes packaging, by the data collection module, the timestamp data, the vehicle type and the camera ID data into the license plate files.
Clause 6. The method of any preceding clause, wherein anonymizing includes transforming, by the anonymization module, characters in the extracted license plate characters into a format which prevents recreation of the extracted license plate characters.
Clause 7. The method of any preceding clause, wherein storing includes indexing, by the data storage module, data in the anonymized license plate files based upon parameters including time, location or camera ID.
Clause 8. The method of any preceding clause, wherein analyzing the anonymized license plate files includes providing the anonymized license plate files to at least one machine learning model and identifying, based upon an output of the at least one machine learning model, the traffic condition.
Clause 9. The method of any preceding clause, wherein analyzing the anonymized license plate files includes receiving, from at least one external data source, external data representing at least one of a current weather condition, a public transportation schedule or special event information.
Clause 10. The method of any preceding clause, further comprising outputting by the data analysis module, a notification regarding the traffic condition to a user interface via a second network.
Clause 11. The method of any preceding clause, wherein the traffic condition includes a traffic volume, a traffic pattern, or a traffic anomaly.
Clause 12. The method of any preceding clause, wherein the component of the traffic management infrastructure is a traffic signal and the aspect adjusted is a timing of operation of the traffic signal.
Clause 13. A traffic analysis system, comprising:
a plurality of cameras, each camera of the plurality of cameras being configured to capture images of license plates on vehicles passing the camera and convert the images into license plate data including license plate characters;
a central server coupled to the plurality of cameras via a first network, the central server including a data collection module, a data anonymization module, a data storage module and a data analysis module; and
a traffic management component coupled to the central server via a second network;
wherein the data collection module is configured to receive the license plate data from the plurality of cameras and package the license plate characters in license plate files;
wherein the anonymization module is configured to anonymize the license plate files; and
wherein the data analysis module is configured to analyze the anonymized license plate files to identify a traffic condition and output at least one command to the traffic management component, thereby causing the component to adjust an aspect of traffic management based upon the identified traffic condition.
Clause 14. The system of clause 13, wherein the data collection module is coupled to the plurality of cameras via the first network to receive the images in near real-time.
Clause 15. The system of any one of clauses 13-14, wherein the data collection module is further configured to extract timestamp data, vehicle type data and camera ID data from the images.
Clause 16. The system of any one of clauses 13-15, wherein the anonymization module is configured to transform characters in the extracted license plate characters into a format which prevents recreation of the extracted license plate characters.
Clause 17. The system of any one of clauses 13-16, wherein the central server further includes at least one machine learning model configured to receive the anonymized license plate files and provide an output the data analysis module uses to identify the traffic condition.
Clause 18. The system of any one of clauses 13-17, wherein the data analysis module is further configured to receive, from at least one external data source, external data representing at least one of a current weather condition, a public transportation schedule or special event information.
Clause 19. The system of any one of clauses 13-18, wherein the traffic management component is a traffic signal and the aspect adjusted is a timing of operation of the traffic signal.
Clause 20. A method for analyzing traffic, comprising:
capturing images of vehicle license plates using a plurality of cameras and converting the images into license plate data including license plate characters;
transmitting the license plate data via a first network to a central server having a data collection module, a data anonymization module, a data storage module and a data analysis module;
extracting, by the data collection module, the license plate characters from the license plate data;
packaging, by the data collection module, the license plate characters in license plate files;
anonymizing, by the anonymization module, the license plate files;
storing, by the data storage module, the anonymized license plate files;
analyzing, by the data analysis module, the anonymized license plate files to identify a traffic condition; and
outputting, by the data analysis module, a notification regarding the traffic condition to at least one user interface.
Clause 21. A method of analyzing traffic information, comprising:
receiving first traffic data via a network at a central server having a data storage module and a data analysis module, wherein the first traffic data including information about vehicle movement;
receiving, from at least one external data source, second traffic data collected from a third party;
merging, by the data analysis module, the first traffic data and the second traffic data into a combined traffic dataset;
analyzing, by the data analysis module, the combined traffic dataset to identify a traffic condition; and
outputting, by the data analysis module, the combined traffic dataset to a user interface.
Clause 22. The method of clause 21, wherein the first traffic data includes license plate data from a vehicle.
Clause 23. The method of any one of clauses 21-22, further comprising:
capturing images of vehicle license plates using a plurality of cameras;
converting the images to license plate data including license plate characters;
transmitting the license plate data via the network to the central server, wherein the central server further includes a data collection module and an anonymization module;
extracting, by the data collection module, the license plate characters from the license plate data;
packaging, by the data collection module, the license plate characters in license plate files; and
anonymizing, by the anonymization module, the license plate files.
Clause 24. The method of any one of clauses 21-23, wherein the first traffic data and the second traffic data each include a vehicle count, and wherein merging the first traffic data and the second traffic data includes modifying the vehicle count from the first traffic data based on the vehicle count from the second traffic data.
Clause 25. The method of any one of clauses 21-24, wherein merging the first traffic data and the second traffic data includes displaying and overlaying the first traffic data and the second traffic data on the user interface.
Clause 26. The method of any one of clauses 21-25, wherein at least one of the first traffic data and the second traffic data includes data collected by sensors at traffic signals.
Clause 27. The method of any one of clauses 21-26, wherein the first traffic data includes information recorded in a first area, and the second traffic data includes information recorded in a second area that is geographically outside the first area.
Clause 28. The method of any one of clauses 21-27, wherein the traffic condition spans across a boundary between the first area and the second area.
Clause 29. The method of any one of clauses 21-28, further comprising:
tracking a first portion of a vehicle trip within the first area based on the first traffic data;
tracking a second portion of the vehicle trip outside the first area based on the second traffic data; and
combining the first and second portions of the vehicle trip, wherein the vehicle trip spans across the boundary between the first area and the second area.
Clause 30. The method of any one of clauses 21-29, further comprising:
exporting the combined traffic dataset to an external analysis device.
Clause 31. The method of any one of clauses 21-30, wherein the traffic condition includes a travel time between a first location and a second location, and further comprising:
receiving, via the user interface, a selection of the first location, wherein at least a first sensor providing first traffic data is positioned at the first location;
receiving, via the user interface, a selection of the second location, wherein at least a second sensor providing first traffic data is positioned at the second location.
Clause 32. The method of any one of clauses 21-31, wherein the traffic condition is an anomaly, and further comprising:
flagging the anomaly, on the user interface, based on a source that recorded data corresponding to the anomaly and a time the data was recorded.
Clause 33. The method of any one of clauses 21-32, wherein at least one of the first traffic data and the second traffic data is recorded by one or more cameras, wherein the anomaly includes a malfunction of one of the cameras, and wherein the malfunction is flagged on the user interface differently than another type of anomaly.
Clause 34. A method of analyzing traffic information, comprising:
receiving first traffic data via a network at a central server having a data storage module and a data analysis module, wherein the first traffic data including information about vehicle movement;
receiving, at the data analysis module, an inquiry sent from a user interface;
analyzing, by the data analysis module, the first traffic data to identify a traffic condition;
determining, by the data analysis module, an answer to the inquiry based on the first traffic data; and
outputting, by the data analysis module, the answer to the user interface in response to the inquiry.
Clause 35. The method of any clause 34, further comprising:
receiving, from at least one external data source, second traffic data collected from a third party; and
combining, by the data analysis module, the first traffic data and the second traffic data into a combined traffic dataset;
wherein the data analysis module determines the answer based on the combined traffic dataset.
Clause 36. The method of any one of clauses 34-35, wherein the data analysis module uses a machine learning algorithm to determine the answer to the inquiry.
Clause 37. The method of any one of clauses 34-36, wherein the answer includes at least one command to at least one component of traffic management infrastructure, thereby causing the component to adjust an aspect of traffic management based upon the identified traffic condition.
Clause 38. The method of any one of clauses 34-37, further comprising:
capturing images of vehicle license plates using a plurality of cameras.
Clause 39. The method of any one of clauses 34-38, further comprising:
converting the images to license plate data including license plate characters.
Clause 40. The method of any one of clauses 34-39, further comprising:
transmitting the license plate data via a network to the central server, wherein the central server further includes a data collection module and an anonymization module.
Clause 41. The method of any one of clauses 34-40, further comprising:
extracting, by the data collection module, the license plate characters from the license plate data.
Clause 42. The method of any one of clauses 34-41, further comprising:
packaging, by the data collection module, the license plate characters in license plate files.
Clause 43. The method of any one of clauses 34-42, further comprising:
   anonymizing, by the anonymization module, the license plate files.
Clause 44. A method of analyzing traffic information, comprising:
   receiving traffic data from a plurality of sensors via a network at a central or distributed server having a data storage module and a data analysis module, wherein the traffic data includes information about vehicle movement from at least one of license plate cameras, radar detectors, LiDAR units, inductive loop detectors, or GPS feeds from connected vehicles;
   analyzing, by the data analysis module, the traffic data to identify a traffic condition; and
   outputting, by the data analysis module, at least one command to traffic management infrastructure based upon the identified traffic condition.
Clause 45. The method of clause 44, wherein the traffic data is received in near real-time, and further comprising:
   packaging, by a data collection module on the distributed server, the traffic data into unified files including timestamps, sensor IDs, and anonymized vehicle identifiers.
Clause 46. The method of any one of clauses 44-45, wherein the distributed server includes edge computing nodes proximate to the plurality of sensors, and wherein preliminary analysis occurs at the edge nodes to generate aggregated results transmitted to the central server.
Clause 47. A traffic analysis system, comprising:
   a plurality of sensors configured to capture traffic data including vehicle movement information, the sensors including at least one of license plate cameras, radar detectors, or inductive loop detectors;
   a distributed server coupled to the plurality of sensors via a network, the distributed server including a data collection module, a data anonymization module, a data storage module, and a data analysis module;
   wherein the data collection module is configured to receive and package the traffic data into files;
   wherein the anonymization module is configured to anonymize the files using at least one of hashing or differential privacy; and
   wherein the data analysis module is configured to analyze the anonymized files to identify a traffic condition and output a command to traffic management infrastructure.
Clause 48. The system of clause 47, wherein the distributed server employs federated learning, wherein machine learning models are trained across decentralized nodes without sharing raw traffic data.
Clause 49. The method or system of any preceding clause, wherein analyzing the traffic data includes providing the traffic data to at least one machine learning model selected from deep neural networks, ensemble methods, or transfer learning models, and identifying the traffic condition based upon an output of the at least one machine learning model.
Clause 50. The method or system of any preceding clause, further comprising:
   training the at least one machine learning model using a combination of historical traffic data, synthetic simulation data, and external data from at least one third-party source.
Clause 51. The method of any preceding clause, further comprising:
   outputting, by the data analysis module, the command to initiate vehicle-to-everything (V2X) communications for dynamic rerouting of connected vehicles based upon the identified traffic condition.
Clause 52. The method of any preceding clause, further comprising:
   correlating the traffic condition with an emissions model to forecast environmental impacts, and outputting a recommendation to activate low-emission zones or optimize electric vehicle charging.
Clause 53. The method of any preceding clause, further comprising:
   integrating the output with emergency services systems to provide real-time route optimization for response vehicles based on predicted traffic delays.
Clause 54. The method or system of any preceding clause, wherein anonymizing the files includes applying differential privacy by adding noise to aggregated datasets or using blockchain-based logging for audit trails.
Clause 55. The method or system of any preceding clause, wherein anonymizing the files further includes adapting to regional data protection standards by using locale-specific algorithms for non-alphanumeric identifiers or multilingual processing.
Clause 56. The method of any preceding clause, further comprising:
   receiving first traffic data recorded in a first geographic area and second traffic data recorded in a second geographic area outside the first geographic area;
   merging the first and second traffic data into a combined dataset spanning a boundary between the first and second geographic areas; and
   analyzing the combined dataset to identify a cross-boundary traffic condition.
Clause 57. The method of clause 56, further comprising:
   tracking a first portion of a vehicle trip within the first geographic area based on the first traffic data;
   tracking a second portion of the vehicle trip within the second geographic area based on the second traffic data; and
   combining the first and second portions to determine an end-to-end trip metric, such as total travel time or average speed.
Clause 58. A method of responsive traffic analysis, comprising:
   receiving traffic data at a server having a data analysis module;
   receiving, at the data analysis module, a natural language inquiry from a user interface;
   analyzing, by the data analysis module using at least one machine learning model, the traffic data to identify a traffic condition;
   determining, by the data analysis module, an answer to the inquiry based on the traffic condition; and
   outputting the answer to the user interface, wherein the answer includes at least one of a forecast, a recommendation, or a command to traffic infrastructure.
Clause 59. The method of clause 58, wherein the natural language inquiry is processed using natural language processing techniques, and the answer is provided in a conversational format via the user interface.
Clause 60. The method or system of any preceding clause, further comprising:
   exporting the combined traffic dataset or analysis outputs to an external device or third-party API, wherein the exported data is further anonymized to remove or mask potentially identifying information.

We claim:

1. A method of analyzing traffic information, comprising:
receiving first traffic data via a network at a central server having a data storage module and a data analysis module, wherein the first traffic data includes information about vehicle movement;
receiving, from at least one external data source, second traffic data collected from a third party;
merging, by the data analysis module, the first traffic data and the second traffic data into a combined traffic dataset;
analyzing, by the data analysis module, the combined traffic dataset to identify a traffic condition; and
outputting, by the data analysis module, the combined traffic dataset to a user interface.

2. The method of claim 1, wherein the first traffic data includes license plate data from a vehicle.

3. The method of claim 2, further comprising:
capturing images of vehicle license plates using a plurality of cameras;
converting the images to license plate data including license plate characters;
transmitting the license plate data via the network to the central server, wherein the central server further includes a data collection module and an anonymization module;
extracting, by the data collection module, the license plate characters from the license plate data;
packaging, by the data collection module, the license plate characters in license plate files; and
anonymizing, by the anonymization module, the license plate files.

4. The method of claim 2, wherein the first traffic data and the second traffic data each include a vehicle count, and wherein merging the first traffic data and the second traffic data includes modifying the vehicle count from the first traffic data based on the vehicle count from the second traffic data.

5. The method of claim 1, wherein merging the first traffic data and the second traffic data includes displaying and overlaying the first traffic data and the second traffic data on the user interface.

6. The method of claim 1, wherein at least one of the first traffic data and the second traffic data includes data collected by sensors at traffic signals.

7. The method of claim 1, wherein the first traffic data includes information recorded in a first area, and the second traffic data includes information recorded in a second area that is geographically outside the first area.

8. The method of claim 7, wherein the traffic condition spans across a boundary between the first area and the second area.

9. The method of claim 8, further comprising:
tracking a first portion of a vehicle trip within the first area based on the first traffic data;
tracking a second portion of the vehicle trip outside the first area based on the second traffic data; and
combining the first and second portions of the vehicle trip, wherein the vehicle trip spans across the boundary between the first area and the second area.

10. The method of claim 1, further comprising:
exporting the combined traffic dataset to an external analysis device.

11. The method of claim 1, wherein the traffic condition includes a travel time between a first location and a second location, and further comprising:
receiving, via the user interface, a selection of the first location, wherein at least a first sensor providing first traffic data is positioned at the first location;
receiving, via the user interface, a selection of the second location, wherein at least a second sensor providing first traffic data is positioned at the second location.

12. The method of claim 1, wherein the traffic condition is an anomaly, and further comprising:
flagging the anomaly, on the user interface, based on a source that recorded data corresponding to the anomaly and a time the data was recorded.

13. The method of claim 12, wherein at least one of the first traffic data and the second traffic data is recorded by one or more cameras, wherein the anomaly includes a malfunction of one of the cameras, and wherein the malfunction is flagged on the user interface differently than another type of anomaly.

14. A method of analyzing traffic information, comprising:
receiving first traffic data via a network at a central server having a data storage module and a data analysis module, wherein the first traffic data includes information about vehicle movement;
receiving, at the data analysis module, an inquiry sent from a user interface;
analyzing, by the data analysis module, the first traffic data to identify a traffic condition;
determining, by the data analysis module, an answer to the inquiry based on the first traffic data; and
outputting, by the data analysis module, the answer to the user interface in response to the inquiry.

15. The method of claim 14, further comprising:
receiving, from at least one external data source, second traffic data collected from a third party; and
combining, by the data analysis module, the first traffic data and the second traffic data into a combined traffic dataset;
wherein the data analysis module determines the answer based on the combined traffic dataset.

16. The method of claim 15, wherein the first traffic data includes information that is recorded in a first area, and the second traffic data includes information recorded in a second area that is geographically outside the first area.

17. The method of claim 15, wherein at least one of the first traffic data and the second traffic data includes data collected by sensors at traffic signals.

18. The method of claim 14, wherein the data analysis module uses a machine learning algorithm to determine the answer to the inquiry.

19. The method of claim 14, wherein the answer includes at least one command to at least one component of traffic management infrastructure, thereby causing the component to adjust an aspect of traffic management based upon the identified traffic condition.

20. The method of claim 14, wherein the first traffic data includes license plate data, and further comprising:
capturing images of vehicle license plates using a plurality of cameras;
converting the images to license plate data including license plate characters;
transmitting the license plate data via the network to the central server, wherein the central server further includes a data collection module and an anonymization module;
extracting, by the data collection module, the license plate characters from the license plate data;
packaging, by the data collection module, the license plate characters in license plate files; and
anonymizing, by the anonymization module, the license plate files.
